(19) United States
(12) Patent Application Publication
(10) Pub. No.: US 2002/0011996 A1
(43) Pub. Date: Jan. 31, 2002

(54) Image display system

(76) Inventors: Akihiko Inoue, Kyoto (JP); Toshihisa Nakano, Nara (JP); Yuji Sato, Nara (JP); Tomoyuki Ishihara, Nara (JP)

Correspondence Address: Dike, Bronstein, Roberts & Cushman, Edwards & Angell, Intellectual Property Practice Group, P.O. BOx 9169, Boston, MA, 02209, US

(21) Appl. No.: 09/864,790

(22) Filed: May 24, 2001

(30) Foreign Application Priority Data
May 24, 2000 (JP) 2000-153877
Mar. 26, 2001 (JP) 2001-88893

(51) Int. Cl. G09G 5/00

(52) U.S. Cl. 345/204

(57) ABSTRACT

An image display system includes: a host section for outputting first data which is image data and second data which is non-image data in a time-division manner; a display section for receiving the first data and the second data output from the host section in the time-division manner; and a single digital interface for transmitting the first data and the second data output from the host section to the display section in the time-division manner, wherein the host section includes: a graphics control circuit for outputting the first data; a data transmission circuit for outputting the second data; and a data output section for receiving the first data output from the graphics control circuit and the second data output from the data transmission circuit and outputting the first data and the second data in the time-division manner, and the display section includes: a data separation section for separating the first data and the second data output by the data output section in the time-division manner; a display circuit for receiving the first data output from the data separation section; and a receiving circuit for receiving the second data output from the data separation section.

### BACKGROUND OF THE INVENTION

1. Field of the Invention

The present invention relates to an image display system including a digital video interface connected to a computer and a display.

2. Description of the Related Art

An exemplary conventional image display system disclosed in Japanese Laid-Open Publication No. 8-331488 in which a personal computer is connected to a color liquid crystal monitor through a video cable is described below.

FIG. 11 is a block diagram showing a structure of a conventional image display system 1000. The image display system 1000 includes a host device 100, a digital video interface 103, and a display device 101. The host device 100 may be included in a personal computer. The host device 100 includes a graphics control circuit 102 for transmitting image data. The display device 101 includes a liquid crystal display circuit 104 for receiving image data and displaying an image on a liquid crystal panel. The digital video interface 103 includes a digital data transmitter 108, a digital data receiver 110, and a video cable 109. The digital video interface 103 connects the graphics control circuit 102 in the host device 100 to the liquid crystal display circuit 104 in the display device 101. Through the digital video interface 103, image data is transmitted from the graphics control circuit 102 to the liquid crystal display circuit 104.

The graphics control circuit 102 includes a graphics controller 107 and a graphics memory 106. The graphics controller 107 receives a drawing instruction from a CPU (not shown) of a personal computer through a system bus 105 and performs arithmetic processing using the graphics memory 106 based on the drawing instruction, thereby generating image data. The graphics controller 107 sequentially outputs the generated image data to the digital data transmitter 108 of the digital video interface 103 by the units of a predetermined data amount.

In the digital video interface 103, image data is transmitted from the digital data transmitter 108 to the digital data receiver 110 through the video cable 109. The image data received by the digital data receiver 110 is converted by a panel control circuit 111 in the liquid crystal display circuit 104 to a data format suitable for controlling a liquid crystal panel 112. The converted image data is sequentially output to the liquid crystal panel 112 for displaying an image on the liquid crystal panel 112 by the units of a predetermined data amount. In the image display system 1000 shown in FIG. 11, only image data can be transmitted through the digital video interface 103.

Next, a conventional image display system 2000 in which sound and an image can be simultaneously transmitted is described. FIG. 12 is a block diagram showing a structure of the image display system 2000. The image display system 2000 includes a host device 200, a display device 201, a digital video interface 203, and a sound cable 217.

The host device 200 can be included in a personal computer. The host device 200 includes a graphics control circuit 202 and a sound signal control circuit 206. The graphics control circuit 202 transmits image data to the display device 201 through the digital video interface 203. The sound signal control circuit 206 transmits a sound signal to the display device 201 through the sound cable 217.

The display device 201 includes a liquid crystal display circuit 204 and a sound output circuit 207. The liquid crystal display circuit 204 receives image data from the graphics control circuit 202 through the digital video interface 203 and displays an image on a liquid crystal panel 214 based on the image data. The sound output circuit 207 receives the sound signal from the sound signal control circuit 206 through the sound cable 217 and generates sound based on the sound signal.

The digital video interface 203 connects the graphics control circuit 202 in the host device 200 to the liquid crystal display circuit 204 in the display device 201. Through the digital video interface 203, image data is transmitted from the graphics control circuit 202 to the liquid crystal display circuit 204.

The sound cable 217 connects the sound signal control circuit 206 in the host device 200 to the sound output circuit 207 in the display device 201. Through the sound cable 217, a sound signal is transmitted from the sound signal control circuit 206 to the sound output circuit 207.

The transmission of image data to be displayed on the liquid crystal panel 214 is performed in a similar manner to that carried out in the image display system 1000 of FIG. 11. Sound data is transmitted in a manner as described below.

The sound signal control circuit 206 includes a sound generation circuit 215 and a sound amplifier 216. The sound generation circuit 215 receives digital sound data from the CPU (not shown) of a personal computer through a system bus 205 and converts the digital sound data to an analog sound signal. The analog sound signal is amplified by the sound amplifier 216 and output to the sound cable 217. The analog sound signal output from the sound amplifier 216 through the sound cable 217 is received by a sound receiving buffer 218 in the sound output circuit 207 and amplified by a sound amplifier 219. The amplified analog sound signal is output to a speaker 220 and sound is emitted by the speaker 220. In the image display system 2000 of FIG. 12, image data and sound data can be transmitted through two cables, i.e., a video cable 211 and the sound cable 217.

In the conventional image display system 1000 of FIG. 11, data other than image data (non-image data) cannot be transmitted from the host device 100 to the display device 101 through the digital video interface 103. Therefore, it is necessary to provide another interface, such as a USB or the like, so as to bridge the host device 100 and the display device 101 for transmitting non-image data therebetween. Alternatively, it is necessary to remove from the display device 101 a device, such as a ROM or the like, which stores non-image data, and rewrite the data in the device.

In the conventional image display system 2000 of FIG. 12, it is possible to simultaneously transmit image data and sound data from the host device 200 to the display device 201. However, it is necessary to provide two interface cables of different types.

Thus, in the conventional systems, in order to transmit non-image data from a host device to a display device, it is necessary to provide another interface in addition to a digital video interface. Moreover, it is necessary to provide a plurality of interfaces of different types. Furthermore, in the case where data stored in a ROM or the like installed in the display device 201 is rewritten, it is necessary to turn off the power to the display device 201 or open a case to pull out the ROM or the like. Such a manipulation consumes time and requires labor.

### SUMMARY OF THE INVENTION

According to one aspect of the present invention, an image display system includes: a host section for outputting first data which is image data and second data which is non-image data in a time-division manner; a display section for receiving the first data and the second data output from the host section in the time-division manner; and a single digital interface for transmitting the first data and the second data output from the host section to the display section in the time-division manner, wherein the host section includes: a graphics control circuit for outputting the first data; a data transmission circuit for outputting the second data; and a data output section for receiving the first data output from the graphics control circuit and the second data output from the data transmission circuit and outputting the first data and the second data in the time-division manner, and the display section includes: a data separation section for separating the first data and the second data output by the data output section in the time-division manner; a display circuit for receiving the first data output from the data separation section; and a receiving circuit for receiving the second data output from the data separation section.

In the image display system having the above features according to the present invention, the host section includes the data output section, the display section includes the data separation section, and the host section and the display section are connected through the single digital interface. In such a structure, image data and various types of non-image data can be simultaneously transmitted through the single digital interface.

In one embodiment of the present invention, each of the first data and the second data output in the time-division manner has a data structure according to a packet format.

In the image display system of the present invention having the above feature, data is transmitted as packet data. Thus, image data and non-image data to be transmitted can be divided into units of data (packets), and the length of each data unit can be freely determined. As a result, various types of non-image data having different data amounts can be efficiently transmitted in such a manner that the types of data can be distinguished.

In one embodiment of the present invention, each of the first data and the second data output in the time-division manner has a plurality of information bits for distinguishing the first data from the second data.

In another embodiment of the present invention, the data separation section separates the first data and the second data output in the time-division manner based on the plurality of information bits.

In still another embodiment of the present invention, the second data includes control data for controlling the display circuit.

In still another embodiment of the present invention, the display section includes a microcomputer which uses the second data; and the second data includes program data for the microcomputer.

In still another embodiment of the present invention, the display section includes an ASIC internal logic circuit; and the second data includes data for initializing the ASIC internal logic circuit.

In still another embodiment of the present invention, the display section includes a sound generation circuit; and the second data includes sound data for the sound generation circuit.

Thus, in the image display system of the present invention, various types of non-image data (data for system control, program for a microcomputer, data for initializing an ASIC internal logic circuit, sound data, etc.) can be transmitted along with image data.

In one embodiment of the present invention, the display circuit includes a memory for storing the first data.

In another embodiment of the present invention, the receiving circuit includes a memory for storing the second data.

In still another embodiment of the present invention, the digital interface is a digital video interface.

According to another aspect of the present invention, a host device includes: a graphics control circuit for outputting first data which is image data; a data transmission circuit for outputting second data which is non-image data; and a data output section for receiving the first data output from the graphics control circuit and the second data output from the data transmission circuit and outputting the first data and the second data in a time-division manner.

The host device of the present invention having the above features includes a means of transmitting image data and non-image data in a time-division manner. In such a structure, both image data and various non-image data can be transmitted together via a single digital interface from the host device to a display device.

In one embodiment of the present invention, each of the first data and the second data output in the time-division manner has a data structure according to a packet format.

The host device of the present invention having the above feature transmits data as packet data. Thus, image data and non-image data to be transmitted can be divided into units of data (packets), and the length of each data unit can be freely determined. As a result, various types of non-image data having different data amounts can be efficiently transmitted in such a manner that the types of data can be distinguished.

In one embodiment of the present invention, the first data and the second data output in the time-division manner is transmitted through a digital interface to a display section which receives the first data and the second data output in the time-division manner.

In another embodiment of the present invention, the digital interface is a digital video interface.

According to still another aspect of the present invention, a display device includes: a data separation section for separating first data and second data output in a time-division manner, the first data being image data and the second data being non-image data; a display circuit for receiving the first data output from the data separation section; and a receiving circuit for receiving the second data output from the data separation section.

The display device of the present invention having the above features includes a means of receiving image data and non-image data in a time-division manner. In such a structure, both image data and non-image data can be transmitted together via a single digital interface from the host device to the display device.

In one embodiment of the present invention, the first data and the second data output in the time-division manner are transmitted from a host device which outputs the first data and the second data in the time-division manner to the display device through a digital interface.

In another embodiment of the present invention, each of the first data and the second data output in the time-division manner has a data structure according to a packet format.

The display device of the present invention having the above features can receive packet data. Thus, various types of non-image data having different data amounts can be efficiently received in such a manner that the types of data can be distinguished.

In one embodiment of the present invention, the display circuit includes a memory for storing the first data.

In another embodiment of the present invention, the receiving circuit includes a memory for storing the second data.

In still another embodiment of the present invention, the digital interface is a digital video interface.

Thus, the invention described herein makes possible the advantage of providing an image display system in which a host device and a display device are connected via a single digital video interface only, whereby image data and various types of non-image data can be simultaneously transmitted.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram showing an image display system according to embodiment 1 of the present invention.

FIG. 2 is a block diagram showing an image display system according to embodiment 2 of the present invention.

FIG. 3 is a block diagram showing an image display system according to embodiment 3 of the present invention.

FIG. 4 is a block diagram showing an image display system according to embodiment 4 of the present invention.

FIG. 5 is a block diagram showing an image display system according to embodiment 5 of the present invention.

FIG. 6 is a block diagram showing an image display system according to embodiment 6 of the present invention.

FIG. 7 is a timing chart showing a timing of outputting data according to embodiment 1 of the present invention.

FIG. 8 is a timing chart showing a timing of outputting data according to embodiment 2 of the present invention.

FIG. 9 is another timing chart showing a timing of outputting data packetized based on a packet format according to embodiment 2 of the present invention.

FIGS. 10A-10C each show a structure of packet data according to the present invention.

FIG. 11 is a block diagram showing a structure of a conventional image display system.

FIG. 12 is a block diagram showing a structure of a conventional image display system in which sound and an image can be simultaneously transmitted via separate interfaces.

### DESCRIPTION OF THE PREFERRED EMBODIMENTS

Hereinafter, embodiments of the present invention will be described with reference to the drawings.

(Embodiment 1)

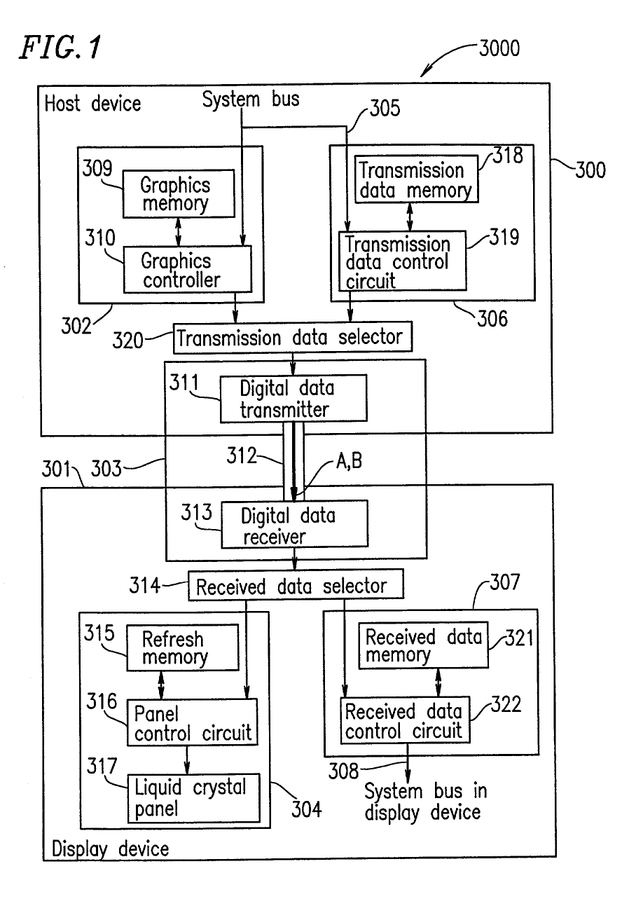

FIG. 1 is a block diagram showing an image display system 3000 according to embodiment 1 of the present invention. In the image display system 3000 image data A and non-image data B are simultaneously transmitted from a host device to a display device via a single interface therebetween. The non-image data B is a different type of data from the image data A.

The image display system 3000 shown in FIG. 1 includes a host device 300, a display device 301, and a digital video interface 303. The host device 300 may be included in a personal computer. The host device 300 includes a graphics control circuit 302, a data transmission circuit 306, and a transmission data selector 320 for selecting data to be transmitted to the display device 301. The display device 301 includes a liquid crystal display circuit 304, a data receiving circuit 307, and a received data selector 314 for selecting received data. The transmission data selector 320 in the host device 300 is connected to the received data selector 314 in the display device 301 through the digital video interface 303. Through the digital video interface 303, both the image data A and the non-image data B are simultaneously transmitted from the host device 300 to the display device 301.

The digital video interface 303 includes an electric cable or an optical fiber as a video cable 312. Furthermore, the digital video interface 303 may transmit the image data A and the non-image data B by radio transmission.

The graphics control circuit 302 includes a graphics controller 310 and a graphics memory 309. The graphics controller 310 performs an arithmetic operation using the graphics memory 309 based on a drawing instruction from a CPU (not shown) of a personal computer through a system bus 305, thereby generating the image data A. The image data A is output to the transmission data selector 320.

The data transmission circuit 306 includes a transmission data memory 318 and a transmission data control circuit 319. The transmission data control circuit 319 receives the non-image data B via the system bus 305 from the CPU of the personal computer and stores the non-image data B in the transmission data memory 318 up to a certain data amount. The non-image data B is retained in the transmission data memory 318 for a predetermined time period and then output to the transmission data selector 320.

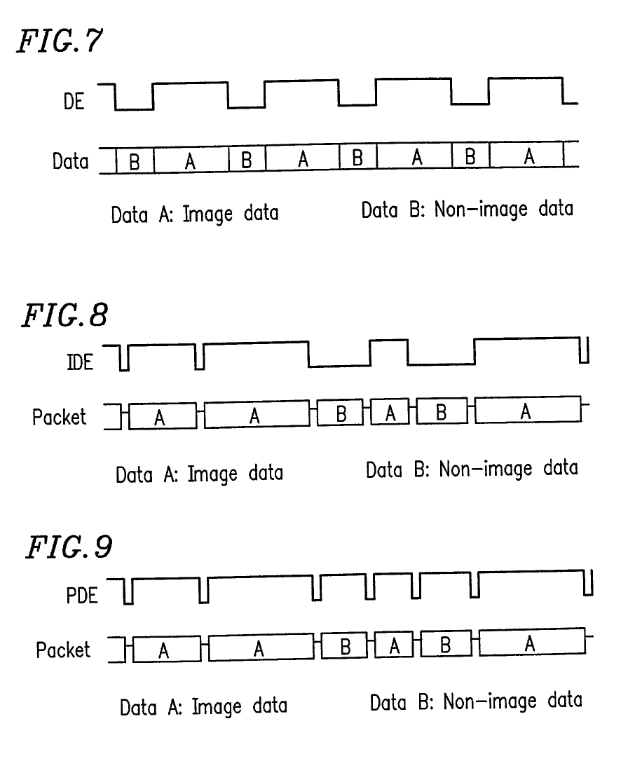

The transmission data selector 320 selects data to be transmitted to a digital data transmitter 311 among the image data A and the non-image data B at the timing of a signal pulse as shown in FIG. 7. As shown in FIG. 7, when a data enable (DE) signal is at a high level, the transmission data selector 320 outputs the image data A obtained from the graphics controller 310 to the digital data transmitter 311. When the DE signal is at a low level, the transmission data selector 320 outputs the non-image data B obtained from the transmission data control circuit 319 to the digital data transmitter 311.

The image data A and the non-image data B are transmitted from the transmission data selector 320 to the digital data transmitter 311 in a time-division manner. For example, the image data A and the non-image data B are transmitted according to a predetermined order as shown in FIG. 7. Alternatively, the image data A and the non-image data B may be transmitted according to an order shown in FIG. 8 or 9 (described later). However, the present invention is not limited to the transmission orders shown in FIGS. 7, 8, and 9. The transmission order of the image data A and the non-image data B is freely controlled, for example, by changing a pattern of the DE signal.

The digital video interface 303 transmits the image data A and the non-image data B from the digital data transmitter 311 to a digital data receiver 313 through the video cable 312. The image data A and the non-image data B received by the digital data receiver 313 are separated by the received data selector 314 where the image data A is output to the liquid crystal display circuit 304, and the non-image data B is output to the data receiving circuit 307. When the DE signal is at a high level, which represents that data output from the digital data receiver 313 is image data A, the received data selector 314 outputs the image data A to the liquid crystal display circuit 304. When the DE signal is at a low level, the received data selector 314 outputs the non-image data B to the data receiving circuit 307.

A panel control circuit 316 in the liquid crystal display circuit 304 receives the image data A from the received data selector 314. The panel control circuit 316 temporarily stores the image data A which corresponds to one frame of a liquid crystal panel 317 in a refresh memory 315 up to a certain data amount, and sequentially outputs the temporarily stored image data A for one frame of the liquid crystal panel 317 to the liquid crystal panel 317 by the units of the certain data amount. Such a refresh operation is repeated, whereby an image is displayed on the liquid crystal panel 317.

A received data control circuit 322 in the data receiving circuit 307 receives the non-image data B from the received data selector 314, and temporarily stores the non-image data B in a received data memory 321 up to a certain data amount. The non-image data B is retained in the received data memory 321 for a predetermined time period and then output to a peripheral circuit (not shown) via a system bus 308 in the display device 301.

In the embodiment illustrated in FIG. 1, the graphics control circuit 302 and the data transmission circuit 306 are separately provided. The graphics control circuit 302 may have functions of the data transmission circuit 306.

(Embodiment 2)

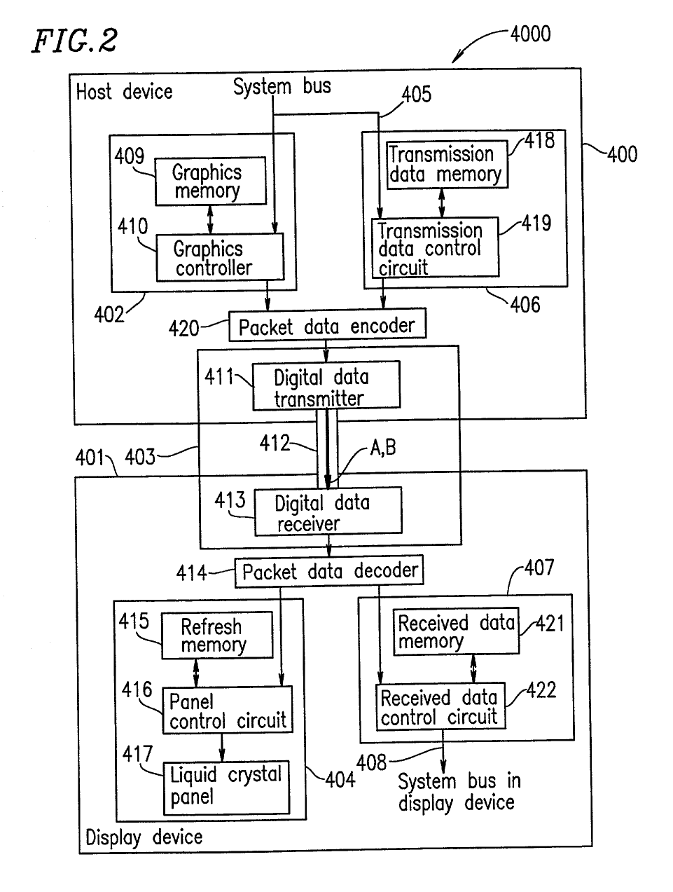

FIG. 2 is a block diagram showing an image display system 4000 according to embodiment 2 of the present invention, in which image data A and non-image data B are transmitted according to a packet transmission system.

In the image display system 4000 of FIG. 2, a host device 400 includes a graphics control circuit 402, a data transmission circuit 406, and a packet data encoder 420 for selecting data to be transmitted to a display device 401 and converting the selected data to a packet format. The host device 400 may be included in a personal computer. A display device 401 includes a liquid crystal display circuit 404, a data receiving circuit 407, and a packet data decoder 414 for reconverting the received data formatted in the packet format into the original data and distributing the reconverted data to the liquid crystal display circuit 404 and the data receiving circuit 407. The packet data encoder 420 and the packet data decoder 414 are connected via a digital video interface 403. Through the digital video interface 403, the image data A and the non-image data B are transmitted from the host device 400 to the display device 401.

The graphics control circuit 402 includes a graphics controller 410 and a graphics memory 409. The graphics controller 410 performs an arithmetic operation using the graphics memory 409 based on a drawing instruction from a CPU (not shown) of a personal computer through a system bus 405, thereby generating the image data A. The image data A is output to the packet data encoder 420.

The data transmission circuit 406 includes a transmission data memory 418 and a transmission data control circuit 419. The transmission data control circuit 419 receives the non-image data B via the system bus 405 from the CPU in the personal computer and stores the non-image data B in the transmission data memory 418 up to a certain data amount. The non-image data B is retained in the transmission data memory 418 for a predetermined time period and then output to the packet data encoder 420.

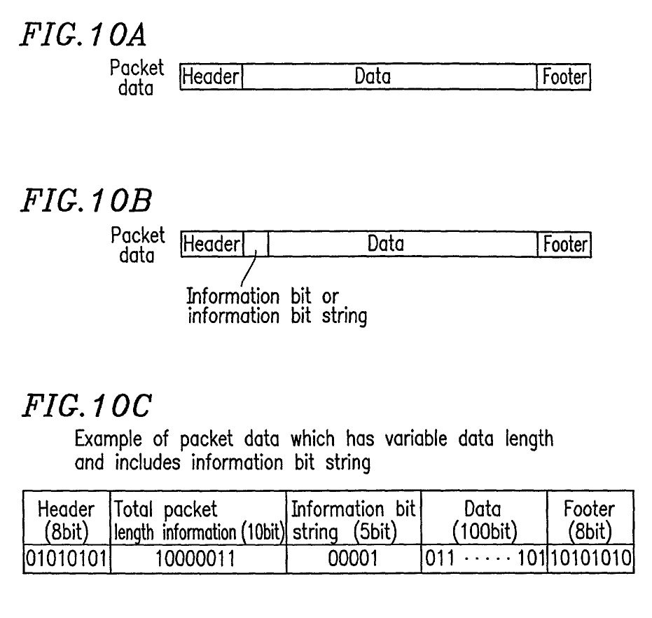

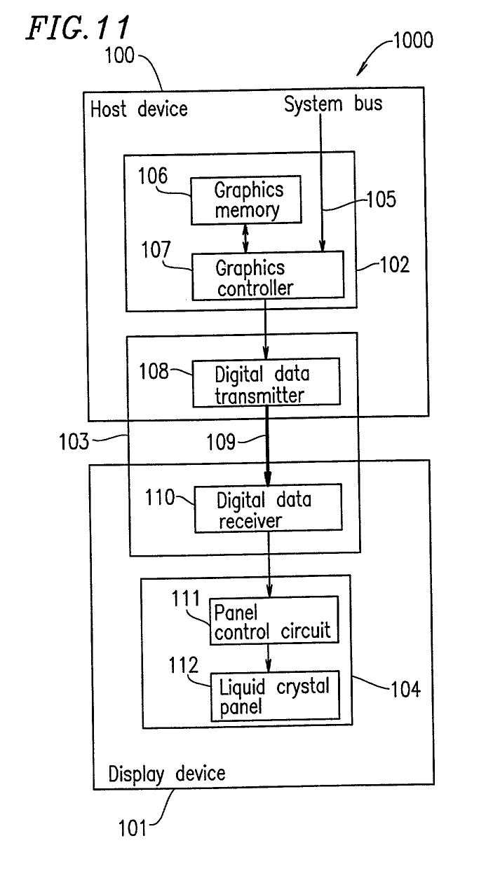

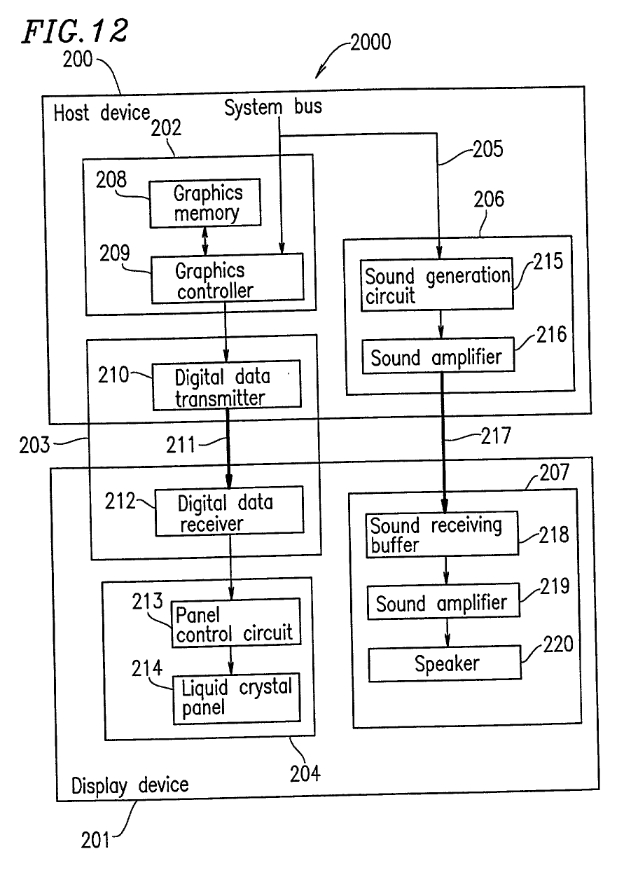

The packet data encoder 420 converts the image data A and the non-image data B into packet data shown in FIG. 10A and outputs the converted data (i.e., packet data) to a digital data transmitter 411 in the digital video interface 403. The packet data encoder 420 determines the order of data to be transmitted to the display device 401 based on data transmission instructions received from the graphics control circuit 402 and the data transmission circuit 406. Then, the packet data encoder 420 selects the image data A obtained from the graphics controller 410 and the non-image data B obtained from the transmission data control circuit 419 according to the determined order of data transmission. The selected data is packetized by adding a header which indicates a head of a packet and a footer which indicates a tail of the packet as shown in FIG. 10A. As a result, the data output from the packet data encoder 420 is dealt with on the units of a packet, and the data length of each packet data can be varied.

The digital video interface 403 transmits the image data A and the non-image data B from the digital data transmitter 411 to a digital data receiver 413 through the video cable 412. The image data A and the non-image data B received by the digital data receiver 413 are separated by the packet data decoder 414 where the image data A is output to the liquid crystal display circuit 404, and the non-image data B is output to the data receiving circuit 407.

FIG. 8 shows an example of packet data output from the packet data encoder 420 and an output timing of an image data enable (IDE) signal. When the IDE signal is at a high level, which represents that data output from the digital data receiver 413 is image data A, the packet data decoder 414 outputs the image data A obtained from the digital data receiver 413 to the liquid crystal display circuit 404. When the IDE signal is at a low level (for example, in the example shown in FIG. 8, when the IDE signal is at a low level for a predetermined time period or longer), the packet data decoder 414 outputs the non-image data B obtained from the digital data receiver 413 to the data receiving circuit 407.

A panel control circuit 416 in the liquid crystal display circuit 404 receives the image data A from the packet data decoder 414. The panel control circuit 416 temporarily stores the image data A which corresponds to one frame of a liquid crystal panel 417 in a refresh memory 415 up to a certain data amount, and sequentially outputs the temporarily stored image data A for one frame of the liquid crystal panel 417 to the liquid crystal panel 417 by the units of the certain data amount. Such a refresh operation is repeated, whereby an image is displayed on the liquid crystal panel 417.

A received data control circuit 422 in the data receiving circuit 407 receives the non-image data B from the packet data decoder 414, and temporarily stores the non-image data B in a received data memory 421 up to a certain data amount. The non-image data B is retained in the received data memory 421 for a predetermined time period and then output to a peripheral circuit (not shown) via a system bus 408 in the display device 401.

In the embodiment illustrated in FIG. 2, the image data A and the non-image data B may be packetized as shown in FIG. 10B. The packet data shown in FIG. 10B includes an information bit. When the information bit is “1”, the packet data is image data A. When the information bit is “0”, the packet data is non-image data B. With the information bit, the image data A and the non-image data B can be distinguished.

Alternatively, as shown in FIG. 9, the image data A and the non-image data B may be selectively transmitted according to a packet data enable (PDE) signal from the packet data encoder 420 to the digital data transmitter 411. The PDE signal of FIG. 9 shows that only when the PDE signal is at a high level, packets are effective.

Another specific example of packet data is shown in FIG. 10C. Using the packet data shown in FIG. 10C, the functions of the packet data encoder 420 and the packet data decoder 414 are now described. The packet data encoder 420 adds to the image data A and the non-image data B, for example, a header of 8 bits (fixed value) which indicates the head of a packet, a footer of 8 bits (fixed value) which indicates a tail of the packet, an information bit string of 5 bits which indicates the type of information to be transmitted, and total packet length information of 10 bits which indicates the calculated number of total bits to be transmitted, thereby generating the packet including serial data shown in FIG. 10C.

The packet data decoder 414 identifies a packet (which is a bunch of data) by the header, the total packet length information, and the footer, and identifies the type of the data by the information bit string, thereby determining a subsequent circuit to which the data is to be transmitted. Then, the packet data decoder 414 selectively outputs the image data A and the non-image data B to a corresponding subsequent circuit.

Alternatively, for example, the image data A and the non-image data B can be converted into packet data including an information bit string by which the type of data can be identified. For example, when the information bit string is “00001”, the packetized data is the image data A; when the information bit string is “00010”, the packetized data is data for controlling the image display system 4000; when the information bit string is “00100”, the packetized data is program data for a microcomputer; when the information bit string is “01000”, the packetized data is data for initializing an internal logic circuit of an application specific integrated circuit (ASIC) (hereinafter, referred to as “ASIC internal logic circuit”); and when the information bit string is “10000”, the packetized data is sound data.

(Embodiment 3)

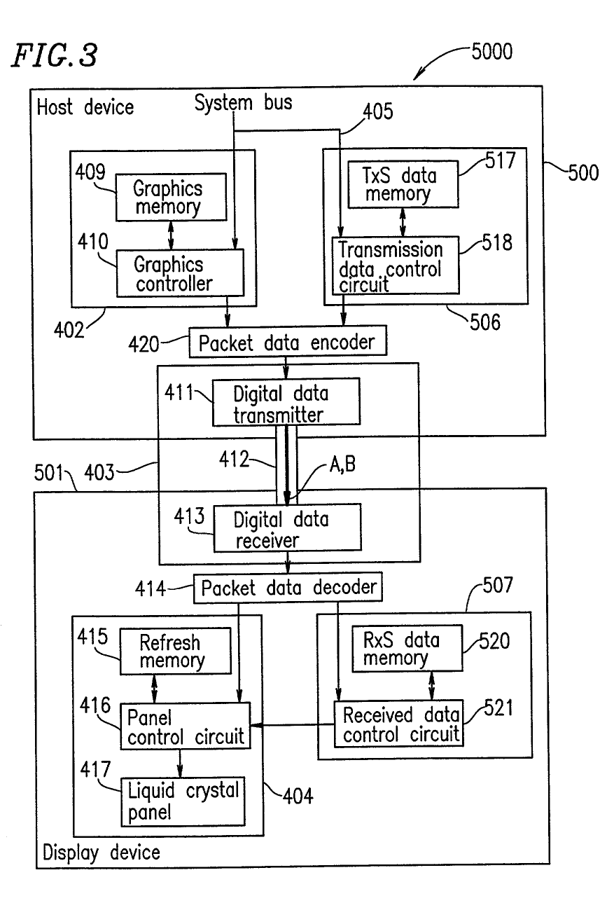

FIG. 3 is a block diagram showing an image display system 5000 according to embodiment 3 of the present invention, in which image data and data for controlling the image display system 5000 are transmitted according to a packet transmission system.

In the image display system 5000, data for controlling the image display system 5000 is transmitted as data B from a host device 500 to a display device 501. The image display system 5000 has substantially the same structure as that of the image display system 4000 shown in FIG. 2 except for a data transmission circuit 506 in the host device 500 and a data receiving circuit 507 in the display device 501.

The data transmission circuit 506 includes a TxS data memory 517 and a transmission data control circuit 518. The transmission data control circuit 518 receives data for controlling the image display system 5000, such as panel definition information, panel size information, etc., via the system bus 405 from the CPU of a personal computer and stores the received data in the TxS data memory 517 up to a certain data amount. The data is retained in the TxS data memory 517 for a predetermined time period and then output to the packet data encoder 420.

The data receiving circuit 507 includes a received data control circuit 521 and an RxS data memory 520. The received data control circuit 521 receives the data for controlling the image display system 5000 from the packet data decoder 414, and temporarily stores the received data in the RxS data memory 520 up to a certain data amount. The data is retained in the RxS data memory 520 for a predetermined time period and then output to the panel control circuit 416 in the liquid crystal display circuit 404.

(Embodiment 4)

FIG. 4 is a block diagram showing an image display system 6000 according to embodiment 4 of the present invention, in which image data and program data for a microcomputer are transmitted according to a packet transmission system.

In the image display system 6000, program data for a microcomputer is transmitted as data B from a host device 600 to a display device 601. The image display system 6000 has substantially the same structure as that of the image display system 4000 shown in FIG. 2 except for a data transmission circuit 606 in the host device 600 and a data receiving circuit 607 in the display device 601 and except that the display device 601 includes a program memory 623 and an OSD (on screen display) control microcomputer 624, and a liquid crystal display circuit 604 includes an image signal coupling circuit 616.

The data transmission circuit 606 includes a TxP data memory 618 and a transmission data control circuit 619. The transmission data control circuit 619 receives program data for the OSD control microcomputer 624 via the system bus 405 from the CPU of a personal computer and stores the received data in the TxP data memory 618 up to a certain data amount. The data is retained in the TxP data memory 618 for a predetermined time period and then output to the packet data encoder 420.

The data receiving circuit 607 includes an RxP data memory 621 and a received data control circuit 622. The received data control circuit 622 receives the program data for the OSD control microcomputer 624 from the packet data decoder 414, and temporarily stores the received data in the RxP data memory 621 up to a certain data amount. The data is retained in the RxP data memory 621 for a predetermined time period and then transmitted to the program memory 623. The OSD control microcomputer 624 receives the program data from the program memory 623 and generates OSD image data according to a control method subscribed by the program data. The OSD image data is transmitted from the OSD control microcomputer 624 to the image signal coupling circuit 616 in the liquid crystal display circuit 604. The image signal coupling circuit 616 carries out superposition processing of the OSD image data and image data from the panel control circuit 416 and outputs the superposition processed data to the liquid crystal panel 417.

(Embodiment 5)

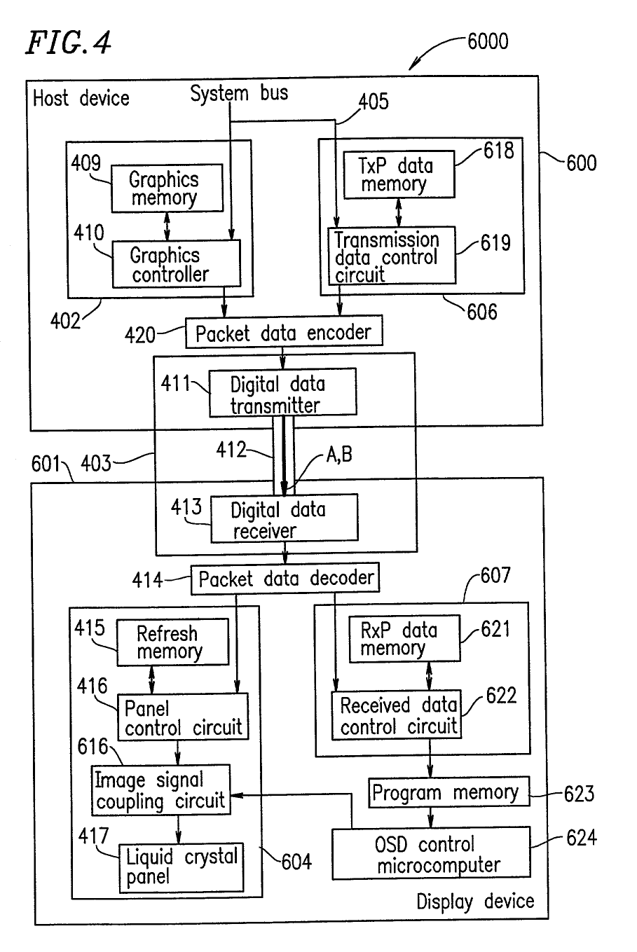

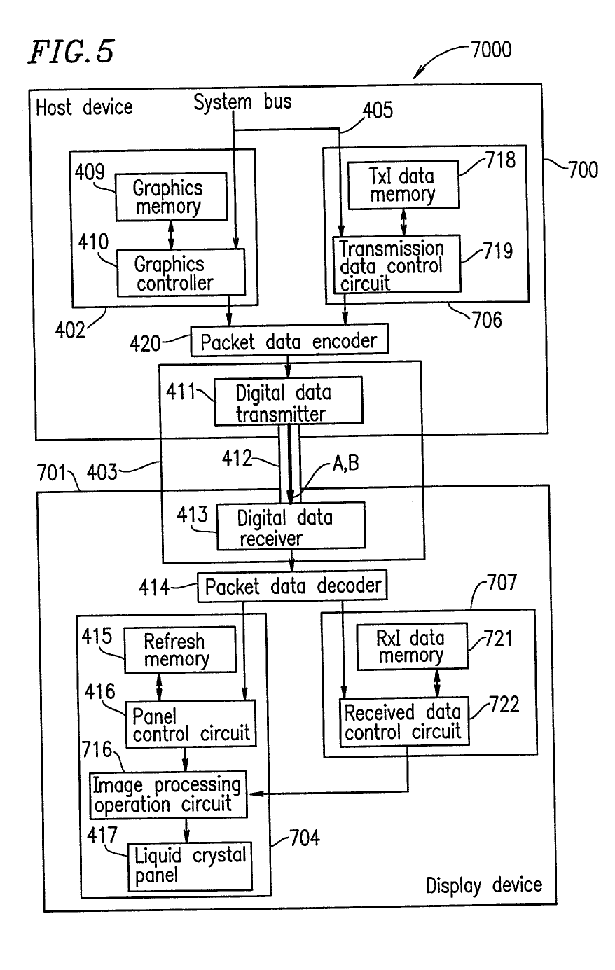

FIG. 5 is a block diagram showing an image display system 7000 according to embodiment 5 of the present invention, in which image data and data for initializing an ASIC internal logic circuit are transmitted according to a packet transmission system.

In the image display system 7000, data for initializing an ASIC internal logic circuit is transmitted as data B from a host device 700 to a display device 701. The image display system 7000 has substantially the same structure as that of the image display system 4000 shown in FIG. 2 except for a data transmission circuit 706 in the host device 700 and a data receiving circuit 707 in the display device 701 and except that a liquid crystal display circuit 704 in the display device 701 includes an image processing operation circuit 716. In this example, the image processing operation circuit 716 corresponds to the ASIC internal logic circuit.

The data transmission circuit 706 includes a TxI data memory 718 and a transmission data control circuit 719. The transmission data control circuit 719 receives data for initializing the image processing operation circuit 716 formed by a field programmable gate array (FPGA) via the system bus 405 from the CPU in the personal computer and stores the received data in the TxI data memory 718 up to a certain data amount. The data is retained in the TxI data memory 718 for a predetermined time period and then output to the packet data encoder 420.

The data receiving circuit 707 includes an RxI data memory 721 and a received data control circuit 722. The received data control circuit 722 receives the data for initializing the image processing operation circuit 716 from the packet data decoder 414, and temporarily stores the received data in the RxI data memory 721 up to a certain data amount. The data is retained in the RxI data memory 721 for a predetermined time period and then transmitted to the image processing operation circuit 716, whereby the image processing operation circuit 716 is initialized. The image processing operation circuit 716 performs image processing on the image data A from the panel control circuit 416 and outputs the processed data to the liquid crystal panel 417.

(Embodiment 6)

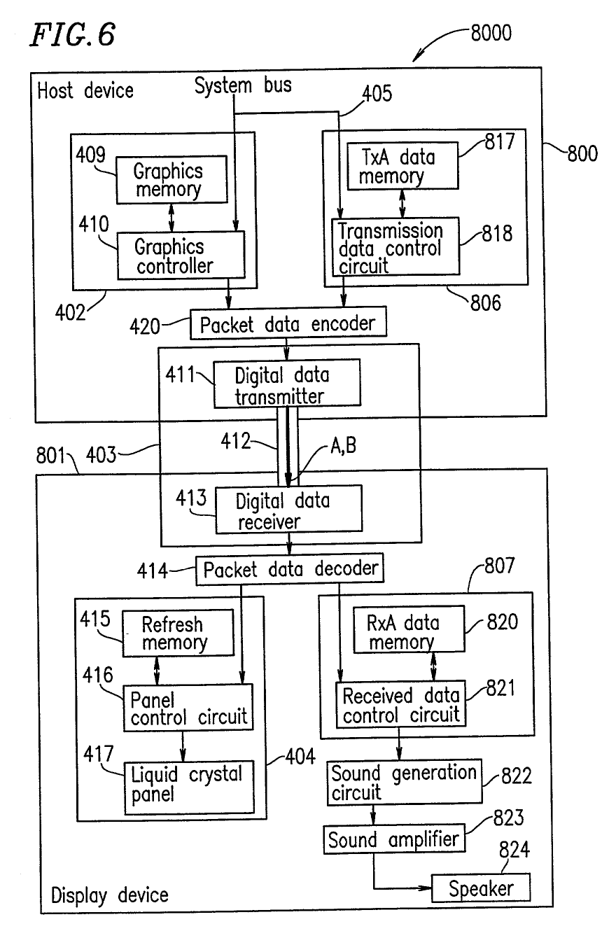

FIG. 6 is a block diagram showing an image display system 8000 according to embodiment 6 of the present invention, in which image data and sound data are transmitted according to a packet transmission system.

In the image display system 8000, sound data is transmitted as data B from a host device 800 to a display device 801. The image display system 8000 has substantially the same structure as that of the image display system 4000 shown in FIG. 2 except for a data transmission circuit 806 in the host device 800 and a data receiving circuit 807 in the display device 801 and except that the display device 801 includes a sound generation circuit 822, a sound amplifier 823, and a speaker 824.

The data transmission circuit 806 includes a TxA data memory 817 and a transmission data control circuit 818. The transmission data control circuit 818 receives digital sound data via the system bus 405 from the CPU of a personal computer and stores the received data in the TxA data memory 817 up to a certain data amount. The data is retained in the TxA data memory 817 for a predetermined time period and then output to the packet data encoder 420.

The data receiving circuit 807 includes an RxA data memory 820 and a received data control circuit 821. The received data control circuit 821 receives the digital sound data from the packet data decoder 414, and temporarily stores the received data in the RxA data memory 820 up to a certain data amount. The data is retained in the RxA data memory 820 for a predetermined time period and then transmitted to a sound generation circuit 822. The sound generation circuit 822 converts the digital sound data into an analog sound signal and outputs the analog sound signal to the sound amplifier 823. The sound amplifier 823 amplifies the analog sound signal and outputs the amplified analog sound signal to the speaker 824.

As described hereinabove, in an image display system of the present invention, a host device includes a transmission data selector, a display device includes a received data selector, and the host device and the display device are connected via a single digital video interface. In such a structure, non-image data used for various purposes (e.g., data for controlling the image display system, program data for a microcomputer, data for initializing an ASIC internal logic circuit, sound data, etc.) can be transmitted together with image data from the host device to the display device via the single digital video interface.

The image display system according to the present invention includes: a host device having a means of transmitting both image data and non-image data; a display device having a means of receiving the image data and the non-image data and separately storing these data; and a single digital video interface for connecting the host device and the display device. In such a structure, various types of non-image data can be transmitted together with image data from the host device to the display device via the single digital video interface.

Further, the data is transmitted according to a packet transmission system. Thus, the image data and the non-image data can be divided into data packets, and the length of each data packet can be freely determined. As a result, various types of non-image data having different data amounts can be efficiently transmitted in such a manner that the types of data can be distinguished.

In a conventional image display system, it is necessary to provide a video interface and other interfaces in parallel between a host device and a display device in order to transmit both image data and various types of non-image data therebetween. In the image display system according to the present invention, with only a single video interface, image data and non-image data (e.g., data for controlling the image display system, program data for a microcomputer, data for initializing an ASIC internal logic circuit, sound data, etc.) can be transmitted together as a single stream of data from the host device to the display device.

Furthermore, the host device of the present invention includes a means of transmitting the image data and the non-image data in a time-division manner. Thus, the image data and the non-image data can be combined and transmitted as a single stream of data from the host device to the display device with only a single video interface.

Further, in such a case, the data is transmitted according to a packet transmission system. Thus, the image data and the non-image data can be divided into data packets, and the length of each data packet can be freely determined. As a result, various types of non-image data having different data amounts can be efficiently transmitted in such a manner that the types of data can be distinguished.

Furthermore, the display device of the present invention includes a means of receiving in a time-division manner the image data and the non-image data transmitted from a host device through a single digital video interface and a means of separately storing the image data and the non-image data. Thus, the image data and the non-image data can be combined and transmitted as a single stream of data from the host device to the display device with only a single video interface.

Further still, the image display system according to the present invention includes a means of receiving and managing data packets. Thus, various types of non-image data having different data amounts can be efficiently transmitted in such a manner that the types of data can be distinguished.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. An image display system, comprising:
a host section for outputting first data which is image data and second data which is non-image data in a time-division manner;
a display section for receiving the first data and the second data output from the host section in the time-division manner; and
a single digital interface for transmitting the first data and the second data output from the host section to the display section in the time-division manner,
wherein the host section includes:
a graphics control circuit for outputting the first data;
a data transmission circuit for outputting the second data; and
a data output section for receiving the first data output from the graphics control circuit and the second data output from the data transmission circuit and outputting the first data and the second data in the time-division manner, and
the display section includes:
a data separation section for separating the first data and the second data output by the data output section in the time-division manner;
a display circuit for receiving the first data output from the data separation section; and
a receiving circuit for receiving the second data output from the data separation section.

2. An image display system according to claim 1, wherein each of the first data and the second data output in the time-division manner has a data structure according to a packet format.

3. An image display system according to claim 2, wherein each of the first data and the second data output in the time-division manner has a plurality of information bits for distinguishing the first data from the second data.

4. An image display system according to claim 3, wherein the data separation section separates the first data and the second data output in the time-division manner based on the plurality of information bits.

5. An image display system according to claim 1, wherein the second data includes control data for controlling the display circuit.

6. An image display system according to claim 1, wherein:
the display section includes a microcomputer which uses the second data; and
the second data includes program data for the microcomputer.

7. An image display system according to claim 1, wherein:
the display section includes an ASIC internal logic circuit; and
the second data includes data for initializing the ASIC internal logic circuit.

8. An image display system according to claim 1, wherein:
the display section includes a sound generation circuit; and
the second data includes sound data for the sound generation circuit.

9. An image display system according to claim 1, wherein the display circuit includes a memory for storing the first data.

10. An image display system according to claim 1, wherein the receiving circuit includes a memory for storing the second data.

11. An image display system according to claim 1, wherein the digital interface is a digital video interface.

12. A host device, comprising:
a graphics control circuit for outputting first data which is image data;
a data transmission circuit for outputting second data which is non-image data; and
a data output section for receiving the first data output from the graphics control circuit and the second data output from the data transmission circuit and outputting the first data and the second data in a time-division manner.

13. A host device according to claim 12, wherein each of the first data and the second data output in the time-division manner has a data structure according to a packet format.

14. A host device according to claim 12, wherein the first data and the second data output in the time-division manner is transmitted through a digital interface to a display section which receives the first data and the second data output in the time-division manner.

15. A host device according to claim 14, wherein the digital interface is a digital video interface.

16. A display device, comprising:
a data separation section for separating first data and second data output in a time-division manner, the first data being image data and the second data being non-image data;
a display circuit for receiving the first data output from the data separation section; and
a receiving circuit for receiving the second data output from the data separation section.

17. A display device according to claim 16, wherein the first data and the second data output in the time-division manner are transmitted from a host device which outputs the first data and the second data in the time-division manner to the display device through a digital interface.

18. A display device according to claim 16, wherein each of the first data and the second data output in the time-division manner has a data structure according to a packet format.

19. A display device according to claim 16, wherein the display circuit includes a memory for storing the first data.

20. A display device according to claim 16, wherein the receiving circuit includes a memory for storing the second data.

21. A display device according to claim 17, wherein the digital interface is a digital video interface.
